(19) United States
(12) Patent Application Publication
(10) Pub. No.: US 2007/0223238 A1
(43) Pub. Date: Sep. 27, 2007

(54) Candle mounting device

(75) Inventor: Bradford Brian Jensen, St. Joseph, MI (US)

Correspondence Address: PATENT GROUP 2N;JONES DAY, NORTH POINT, 901 LAKESIDE AVENUE, CLEVELAND, OH, 44114, US

(73) Assignee: The Lamson & Sessions Co.

(21) Appl. No.: 11/446,898

(22) Filed: Jun. 5, 2006

Related U.S. Application Data
(60) Provisional application No. 60/786,306, filed on Mar. 27, 2006.

(51) Int. Cl. F21V 35/00

(52) U.S. Cl. 362/392; 362/161

(57) ABSTRACT

A real or artificial candle is centered on an axis and has axially top and bottom ends. A plug, connected to the bottom end, has circumferentially spaced elastic wings. Each wing extends upward and has a radially inner surface and a radially outer surface. The radially outer surfaces follow a common conical contour centered on the axis. The radially outer surfaces are configured to be flexed radially inward by a candle holder as the plug is inserted into a bore of the holder and to elastically and frictionally engage the holder to secure the plug and thus the candle to the holder.

### CROSS-REFERENCE TO RELATED APPLICATION

This application claims the benefit of U.S. Provisional Application No. 60/786,306, filed Mar. 27, 2006.

### TECHNICAL FIELD

This application relates to candles and candleholders.

### BACKGROUND

An artificial candle has a tube that simulates a candle and can be mounted in a candleholder.

### SUMMARY

A real or artificial candle is centered on an axis and has axially top and bottom ends. A plug, connected to the bottom end, has circumferentially spaced elastic wings. Each wing extends upward and has a radially inner surface and a radially outer surface. The radially outer surfaces follow a common conical contour centered on the axis. The radially outer surfaces are configured to be flexed radially inward by a candle holder as the plug is inserted into a bore of the holder and to elastically and frictionally engage the holder to secure the plug and thus the candle to the holder.

Preferably, each radially outer surface is configured to frictionally engage the holder along a circumferentially extending band of contact with an arc angle of about 45° or more. The sum of arc angles of the bands is about 180° or more. Gaps between the wings circumferentially narrow with increasing penetration of the plug into the bore. The conical contour has a conic angle of about 20° or more in the unflexed state. The radially inner surfaces follow a common conical contour and are configured to flex in concert with the outer surfaces. The radially inner and outer surfaces of each wing extend from a lower proximal end of the wing, adjoining the structure, to an upper distal end of the wing.

### BRIEF DESCRIPTION OF THE DRAWINGS

FIG. 1 is a perspective view of an artificial candle and a candleholder;

FIG. 2 is an exploded sectional view of the candle;

FIG. 3 is a sectional view of a bottom portion of the candle;

FIG. 4 is a side view of the bottom portion shown spaced above the candleholder;

FIG. 5 is a perspective view of the bottom portion mounted in the candleholder; and

FIG. 6 is a perspective view of the bottom portion mounted in another candleholder.

### DESCRIPTION

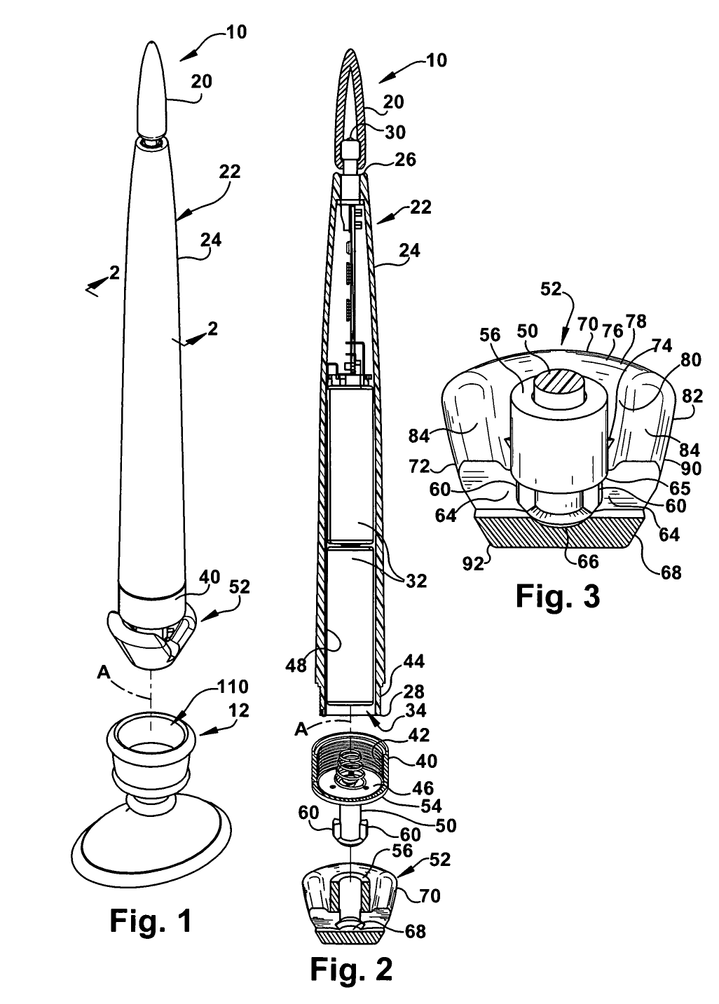

The apparatus shown in FIG. 1 has parts that are examples of the elements recited in the claims. The apparatus thus includes examples of how a person of ordinary skill in the art can make and use the claimed invention. It is described here to meet the requirements of enablement and best mode without imposing limitations that are not recited in the claims.

The apparatus includes an electric artificial candle 10 configured to be inserted into a candleholder 12. The candle 10 includes a translucent flame piece 20 simulating a candle flame and a base 22 simulating a wax candle. In the following description of the candle 10, directional terms such as “top” and “upward” are made only with respect to the orientations shown in the figures.

As shown in FIG. 2, the base 22 includes a plastic tube 24 centered on an axis A, with axially top and bottom ends 26 and 28. The flame piece 20 is mounted at the top end 26. It encases an LED lamp 30, powered by batteries 32, that causes the flame piece 20 to glow. The batteries 32 are stacked end-to-end within the tube 22. They can be replaced through an access opening 34 at the bottom 28 of the tube 24.

The access opening 34 is covered by a cap 40 with an internal screw thread 42 that mates with an external screw thread 44 of the tube 24. The cap 40 retains the batteries 32 in the tube 24. The cap 40 also serves as an on/off switch. To turn the lamp 30 on, the cap 40 is turned clockwise until a metal plate 46 in the cap 40 contacts a metal strip 48 mounted in the tube 24 to complete an electrical circuit that powers the lamp 30. To turn the lamp 30 off, the cap 40 is turned counterclockwise to move the plate 46 away from the strip 48 and break the circuit.

The candle 10 is retained in the candleholder 12 (FIG. 1) by a mounting structure comprising a rigid post 50 and a one-piece rubber plug 52. The post 50 projects downward from the bottom 54 of the cap 40 and is inserted through a ring 56 of the plug 52. During insertion, the ring 56 elastically expands to ride up and over two wedges 60 on the post 50.

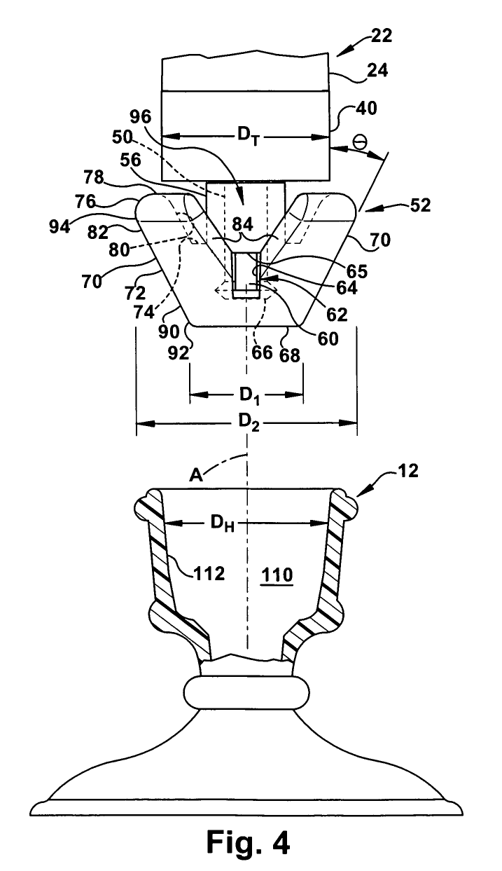

After insertion, as shown in FIGS. 3-4, each wedge 60 protrudes through a respective hole 62 in the plug 52. The wedge 60 abuts two opposite side surfaces 64 and an upper end surface 65 that bound the hole 62. This prevents the plug 52 from rotating about or being withdrawn from the post 50. The bottom 66 of the post 50 abuts a base 68 of the plug 52. The plug 52 is thus connected by the post 50 to the cap 40 of the candle 10.

The plug 52 has wings 70 extending upward and radially-outward from the base 68. They are identical and spaced symmetrically about the axis A. Each wing 70 has a lower proximal end 72, adjoined to both the base 68 and the ring 56 by a ribbed connecting structure 74, and an upper distal end 76. Each wing 70 further has a circumferentially-extending top surface 78 at the distal end 76, a radially inner surface 80, a radially outer surface 82 and two circumferentially opposite side surfaces 84.

The radially inner surfaces 80 follow a common conical contour. Similarly, the radially outer surfaces 82 follow a common conical contour and are portions of an outer frustoconical surface 90. This surface 90 extends from an annular bottom edge 92 to the two arcuate top surfaces 78 and is interrupted by gaps 96 between the wings 70. Each gap 96 is V-shaped and bounded by the side surfaces 84.

FIG. 4 shows the plug 52 in its unflexed, i.e., natural, state. The frustoconical surface 90 has a diameter that increases, preferably linearly, from a minor value D₁ at its bottom edge 92 to a major value D₂ at the top 94. The surface 90 is inclined relative to the axis A at a conic angle θ of about 20° or more, and of preferably about 30°. The diameter D_{H} of the bore 110 of the candleholder 12 is in the range of D₁ to D₂.

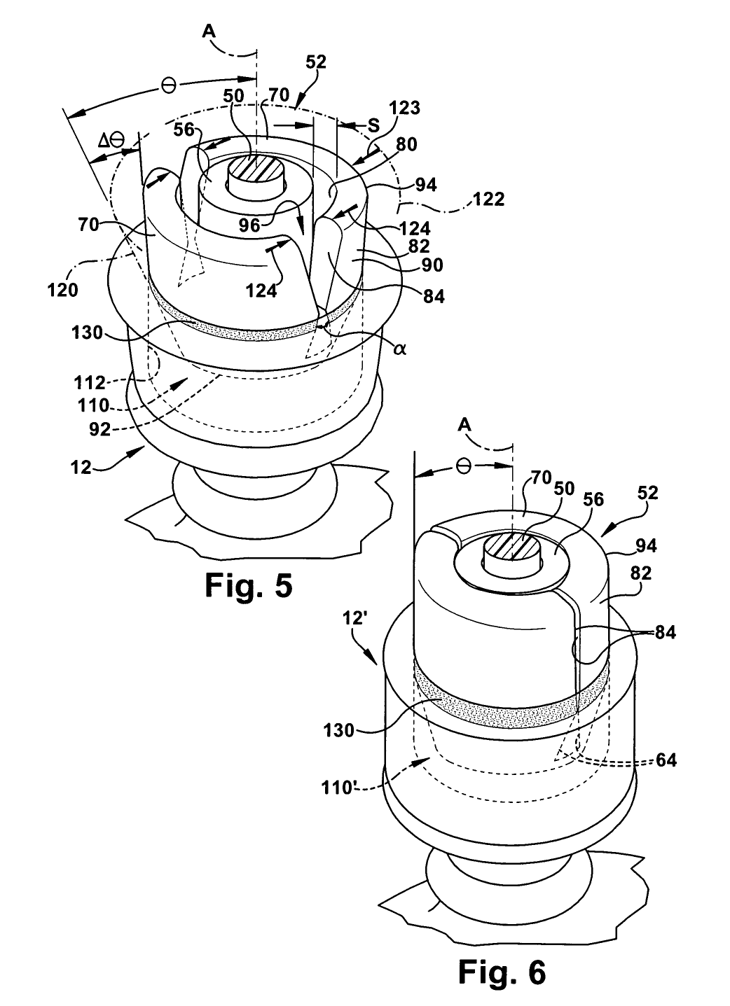

To mount the candle 10 in the holder 12, a user grasps the tube 24 and pushes the plug 52 into the candleholder bore 110 as shown in FIG. 5. The cylindrical surface 112 surrounding the bore 110 squeezes the plug 52, reducing its circumference by bending each wing 70 radially inward. Each inner and outer surface 80 and 82 flexes along its vertical length, flexes along its circumferential width, and pivots about the ribbed connecting structure 74 (FIG. 4). The spacing S between the inner surface 80 and the ring 56 provides room for the inner surface 80 to bend radially inward in concert with bending of the outer surface 82. Due to the flexing of the side profile of the outer surface 90, the conical contour of the outer surface 90 becomes domed.

Dot-dash line 120 in FIG. 5 outlines the unflexed side profile of the frustoconical surface 90. It illustrates that the flexing and pivoting of the wings 70 reduces the conic angle η by an angle Δθ near the top 94 of the outer surface 90.

Dot-dash line 122 outlines an imaginary circular path initially followed by the unflexed top edges 94 of the wing outer surfaces 82. Flexing of the wings 70 shrinks (arrows 123) this imaginary path 122, while the sum of the lengths of the top edges 94 remains the same. Consequently, the arc angle of each top edge 94 increases. This, in turn, forces the gaps 96 to narrow (arrows 124). The gaps 96 thus provide room for the top edges 94 and side surfaces 84 of the wings 70 to approach each other as the plug 52 squeezes into the bore 110.

Elastic force of the wings 70 against the holder 12 provides friction that prevents slippage between the wings 70 and the holder 12 in the axial and circumferential directions. This fixes the position of the plug 52, and thus the position of the cap 40 (FIG. 1), relative to the holder 12. With the cap 40 fixed in place, the tube 24 is fixed axially but can be twisted in one direction to turn the lamp 30 on and in the opposite direction to turn the lamp 30 off.

The friction between each wing 70 and the holder 12 is applied along an uninterrupted circumferentially-extending band of frictional contact 130, shown stippled in FIG. 5. The friction bands 130 are separated by the gaps 96, which narrow as the plug 52 is squeezed into the bore 110. In this example, each band 130 spans an arc angle of about 45° or more, and preferably about 90° or more, with the sum of the arc angles being about 180° or more. Each gap 96 between the bands 130 spans an arc angle α of about 20° or more, and the sum of the arc angles α is about 40° or more.

FIG. 6 shows the plug 52 inserted into another holder 12′. The bore 110′ of this holder 12′ is diametrically smaller than in the above example and is about the same as that of the tube 24 (FIG. 1) and the cap 40. In this case, the wings 70 are squeezed radially inward until they contact each other and eliminate the gap 96 (FIG. 5). The wings′ side surfaces 84, which were angled away from each other in the unflexed state (FIG. 4), now contact each other along their lengths. The side surfaces 64 beside the wedges 60 (FIG. 4), which were parallel in the unflexed configuration, are now angled away from each other in an inverted V-shape. Near the top 94 of the outer surfaces 82, the conic angle θ, which was about 30° in the unflexed condition, is now about 0°, so that the outer surfaces 82 define a cylindrical shape with a diameter about equal to D_{T} (FIG. 4). The sum of arc angles of the friction bands 130 is almost 360°—but not fully 360° in this example, because the wings' side surfaces 84 have rounded edges.

In this example, the plug 52 mounts an artificial candle 22 (FIG. 1) to a candleholder 12. Alternatively, the plug 52 can mount a real wax candle to a candleholder. In that case, the ring 56 of the plug 52 could be configured to grasp the bottom of the candle instead of the post 50.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have elements that do not differ from the literal language of the claims, or if they include equivalent structural elements with insubstantial differences from the literal language of the claims.

1. A candle apparatus comprising:
a real or artificial candle extending along an axis and having axially top and bottom ends; and
a plug connected to the bottom end and having circumferentially spaced elastic wings, each wing extending upward and having a radially inner surface and a radially outer surface, the radially outer surfaces following a common conical contour centered on the axis and configured to be flexed radially inward by a candle holder as the plug is inserted into a bore of the holder and to elastically and frictionally engage the holder to secure the plug and thus the candle to the holder.

2. The apparatus of claim 1 wherein each radially outer surface is configured to frictionally engage the holder along a circumferentially extending band of contact with an arc angle of about 45° or more.

3. The apparatus of claim 2 wherein the arc angle is about 90° or more.

4. The apparatus of claim 1 wherein each radially outer surface is configured to frictionally engage the holder along a circumferentially extending band of contact, the sum of the arc angles of the bands being about 180° or more.

5. The apparatus of claim 1 wherein the plug is configured for gaps between the wings to circumferentially narrow with increasing penetration of the plug into the bore.

6. The apparatus of claim 5 wherein adjacent side surfaces of the wings can contact each other if the bore is sufficiently narrow.

7. The apparatus of claim 6 wherein the adjacent side surfaces form a V-shape in the unflexed state, and can contact each other along their lengths if the bore is sufficiently narrow.

8. The apparatus of claim 1 wherein the conical contour has a conic angle of about 20° or more in the unflexed state.

9. The apparatus of claim 8 wherein the plug is configured to enable the conic angle to be reduced to about 0° by insertion of the plug into a sufficiently narrow bore.

10. The apparatus of claim 1 wherein the radially inner surfaces follow a common conical contour.

11. The apparatus of claim 1 wherein the inner surfaces are configured to flex in concert with the outer surfaces.

12. The apparatus of claim 1 wherein the radially inner and outer surfaces of each wing extend from a lower proximal end of the wing to an upper distal end of the wing, the proximal end being adjoined to the candle bottom end through the proximal end.

13. A candle apparatus comprising:
a real or artificial candle extending along an axis and having axially top and bottom ends; and
a plug connected to the bottom end and having a frustonical surface extending upward and radially outward with a conic angle of about 20° or more, and configured to be inserted into a bore of a candle holder and frictionally engage the holder to secure the plug and thus the candle to the holder.

14. The apparatus of claim 13 configured for the conic angle to be reduced to about 0° by insertion of the plug into a sufficiently narrow bore.

15. The apparatus of claim 13 wherein the outer surface is configured to frictionally engage the holder along circumferentially extending bands of contact that are circumferentially spaced apart, each band spanning an arc angle of about 45° or more.

16. The apparatus of claim 13 wherein the outer surface is configured to frictionally engage the holder along circumferentially extending bands of contact, and the sum of arc angles of the bands is about 180° or more.

17. The apparatus of claim 16 configured for the sum to be about 360° if the bore is sufficiently narrow.
